(19) United States
(12) Patent Application Publication
(10) Pub. No.: US 2009/0228610 A1
(43) Pub. Date: Sep. 10, 2009

(54) STORAGE SYSTEM, STORAGE APPARATUS, AND CONTROL METHOD FOR STORAGE SYSTEM

(75) Inventor: Tsuyoshi UCHIDA, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/350,289

(22) Filed: Jan. 8, 2009

(30) Foreign Application Priority Data
Mar. 10, 2008 (JP) 2008-059658

(51) Int. Cl. G06F 13/00; G06F 3/00; G06F 12/00

(52) U.S. Cl. 710/5; 711/154; 711/114; 711/E12.001

(57) ABSTRACT

The storage apparatus has a detecting unit that detects the number of a server connecting to the storage apparatus, a determining unit that determines the change of the set upper limit value set for the server on the basis of the number of the server detected by the detecting unit, and a notifying unit that performs change notification regarding the change of the set upper limit value determined by the determining unit to the server. The server has a change notification receiving unit that receives the change notification from the notifying unit, and a changing unit that changes the set upper limit value set for the server on the basis of the change notification received by the change notification receiving unit.

### CROSS-REFERENCE TO RELATED APPLICATIONS

This application is based upon and claims the benefit of priority of the prior Japanese Patent Application No. 2008-59658, filed on Mar. 10, 2008, the entire contents of which are incorporated herein by reference.

### FIELD

The embodiment discussed herein is related to a technology for setting the upper limit value of the number of commands to be issued by a server in a storage apparatus connecting to the server, such as a RAID (Redundant Arrays of Inexpensive Disks) apparatus.

### BACKGROUND

In a RAID (Redundant Arrays of Inexpensive Disks) apparatus, for example, multiple commands are issued by a server, and a limited number of commands of the multiple commands can be received by one FC (Fibre Channel) port simultaneously. The limited number of commands that can be received by one FC port simultaneously will be simply called the number of receivable commands.

FIG. 1 is a diagram schematically showing a configuration example of a conventional storage system.

A storage system 90 includes, as shown in FIG. 1, a RAID apparatus 91 and a server 92A connecting to the RAID apparatus 91. The RAID apparatus 91 includes a controller 93 that controls communication with the server 92A. The server 92A includes an HBA (Host Bus Adapter) 94A for connecting to an FC port 930 of the RAID apparatus 91.

For example, as shown in FIG. 1, if the RAID apparatus 91 receives commands (refer to the sign “P” in FIG. 1) more than the number of receivable commands from the server 92A, a command error occurs. And the RAID apparatus 91 notifies the server 92A of Busy or Queue Full as a SCSI (Small Computer System Interface) status (refer to the sign “Q” in FIG. 1).

On the other hand, the server 92A having received the notification of Busy or Queue Full can perform processing of temporarily aborting the issuance of commands.

In order to notify Busy or Queue Full and temporarily abort the issuance of commands, Japanese Laid-open Patent Publication No. 2004-206623 discloses that a system load is calculated on the basis of information from an I/O control module that controls the number of receivable I/O commands and information from a backend module that performs processing of accessing a storage apparatus and the number of receivable commands by a host I/O is adjusted by responding Busy or Queue Full to the host so that the issuance of commands can be suppressed until the number of commands being executed by the backend module reaches a threshold value.

However, in the method that notifies Busy or Queue Full, a part of an OS (Operating System) in the server cannot perform processing properly in response to the notification, which may prevent the abort of the issuance of commands. For that reason, the generation of command errors is desirably suppressed as much as possible in the RAID apparatus 91.

FIG. 2 is a diagram schematically showing an example of the setting of a Max Throttle in a conventional storage system. FIG. 3 is a diagram schematically showing a case where a server to be connected to a RAID apparatus in a conventional storage system is newly added.

The server 92A may have the setting of a Max Throttle, which is an upper limit value of the number of simultaneous issuable commands by one server 92A, in accordance with the number of receivable commands in the RAID apparatus 91.

For example, in the storage system 90 shown in FIG. 2, if the number of receivable commands of the RAID apparatus 91 is 40, the Max Throttle of the server 92A corresponding to the RAID apparatus 91 is set to 40, which is equal to the number of receivable commands, or a value under the number of receivable commands.

Then, the server 92A sequentially issues commands at predetermined time intervals so as not to exceed the set value of the Max Throttle. If the number of simultaneously issued commands reaches the value of the Max Throttle, for example, the server 92A temporarily aborts the issuance of commands.

Notably, the conventional storage system 90 may use an HBA driver of the server 92A (not shown) to manually (or statically) set the Max Throttle or use firmware (not shown) of the HBA of the server 92A to manually set the Max Throttle.

In the conventional storage system 90 however, one server 92A may connect to the FC port 930 of the RAID apparatus 91 through an FC switch 95 (refer to FIG. 2). In the environment, in order to change the system configuration such that another server 92B can be connected to the FC port 930 of the RAID apparatus 91 through the same FC switch 95 as shown in FIG. 3, the necessities arise not only for manually setting the Max Throttle of the newly added server 92B (to 20 in the example shown in FIG. 3) but also for manually changing the setting of the Max Throttle of the already connected server 92A in operation (that is, resetting from 40 to 20 in the example shown in FIG. 3).

Even when the default value compatible with the RAID apparatus 91 is set upon connection as the Max Throttle of the newly added server 92B, the sum of the default value set in the newly added server 92B and the Max Throttle of the running server 92A may be higher than the number of receivable commands of the RAID apparatus 91. In this case, the Max Throttles of the newly added server 92B and running server 92A must be changed manually.

This increases the number of servers connecting to the RAID apparatus 91. As the size of the storage system 90 increases, the amounts of time and labor required for changing the setting of the Max Throttles increase because all the Math Throttles of the servers 92A and 92B have to be manually changed.

In a larger storage system, a system disk image constructed by one server may be copied to another server for efficiently perform the works for constructing the storage system. However, because the work is required for manually resetting the Max Throttles for servers in accordance with the environment, the time and labor are required for changing the settings of the Max Throttles also in this case.

The number of HBAs connecting to one FC port may be counted, and the number of receivable commands of the RAID apparatus connecting to the FC port may be divided by the number of HBAs. In many cases however, the number of HBAs may be counted incorrectly, or an improper value may be applied as the set number of receivable commands. Then, an incorrect value may be set as the Max Throttles of servers. As a result, there is a possibility of delaying the processing of commands issued by the servers or causing a command error.

In setting the Max Throttles manually, the operational states of servers must be considered for proper setting. However, it is difficult to follow the dynamically changing operational states.

For example, in an HA (High Availability) cluster, a set upper limit value of the assignment ratio 90% may be assigned to one running server while a set upper limit value of the assignment ratio 10% may be assigned to the other standby server, and the running server and the standby server are switched alternately at a predetermined time. In the HA cluster however, it is difficult for the assignment ratios of Max Throttles of servers to follow the switching between the running server and the standby server. Then, the Max Throttle of the assignment ratio 90% is assigned to the one switched from the running state to the standby state while the Max Throttle of the assignment ratio 10% is assigned to the other server switched from the standby state to the running state. Therefore, every switching between the running state and the standby state requires the manual resetting such that the Max Throttle of the assignment ratio 90% and the Max Throttle of the assignment ratio 10% can be assigned to the running server and the standby server, respectively.

Japanese Laid-open Patent Publication No. 2004-206623 only discloses the suppression of the issuance of commands by responding Busy or Queue Full to a host and does not mention about the setting or changing the Max Throttle of the host.

### SUMMARY

According to an aspect of the invention, there is provided a storage system including a server for which a set upper limit value is set, the set upper limit value being an upper limit value of the number of issuable commands, and a storage apparatus that processes the commands issued by the server. The storage apparatus includes a detecting unit that detects the number of the server connecting to the storage apparatus, a determining unit that determines the change of the set upper limit value set for the server on the basis of the number of the server detected by the detecting unit, and a notifying unit that performs change notification regarding the change of the set upper limit value determined by the determining unit to the server. The server has a change notification receiving unit that receives the change notification from the notifying unit, and a changing unit that changes the set upper limit value set for the server on the basis of the change notification received by the change notification receiving unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram schematically showing a configuration example of a conventional storage system;

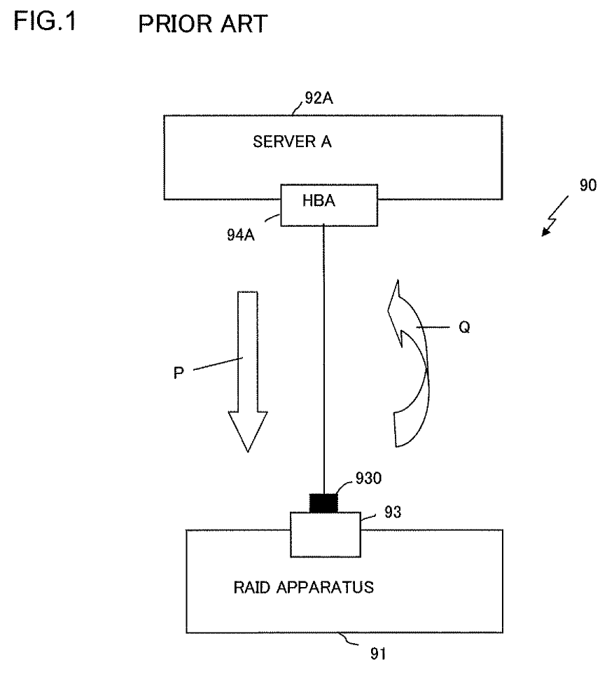

FIG. 2 is a diagram schematically showing a setting example of the Max Throttle in the conventional storage system;

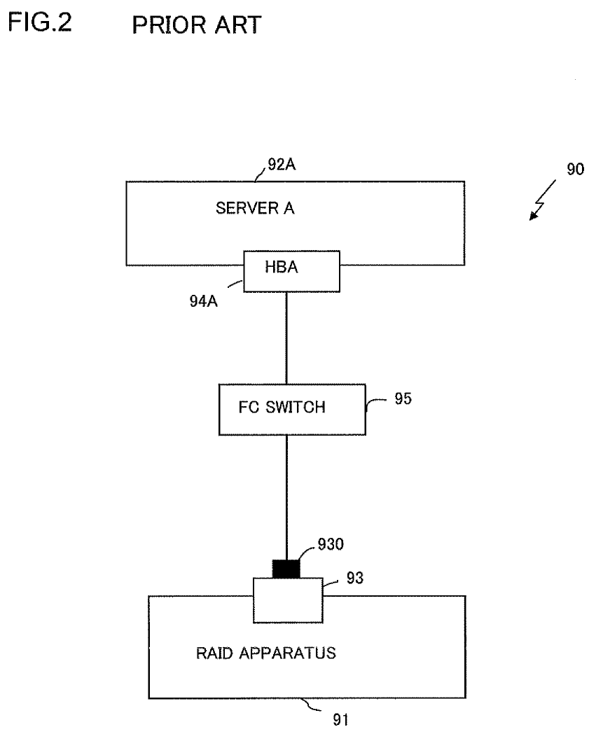

FIG. 3 is a diagram schematically showing a case where a server connecting to a RAID apparatus is newly added in the conventional storage system.

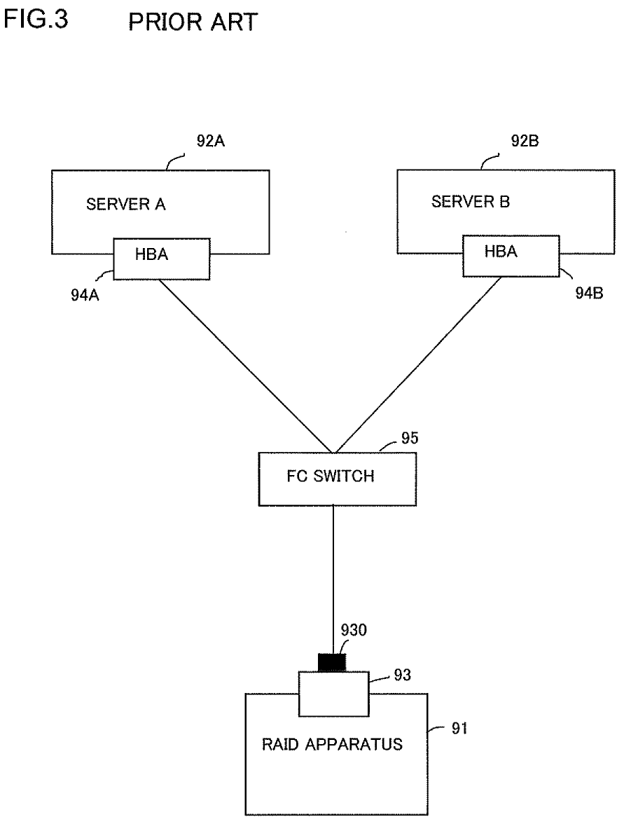

FIG. 4 is a diagram schematically showing a configuration example of the storage system as an embodiment of the present technique;

FIG. 5 is a diagram schematically showing a configuration example in a case where a server is newly added to the storage system as an embodiment of the present technique;

FIG. 6 is a diagram for explaining a first aspect as an example of the method for changing a set upper limit value, which is set for a server, in the storage system as an embodiment of the present technique;

FIG. 7 is a diagram for explaining a second aspect as an example of the method for changing a set upper limit value, which is set for a server, in the storage system as an embodiment of the present technique;

FIG. 8 is a diagram for explaining a third aspect as an example of the method for changing a set upper limit value, which is set for a server, in the storage system as an embodiment of the present technique;

FIG. 9 is a diagram for explaining a fourth aspect as an example of the method for changing a set upper limit value, which is set for a server, in the storage system as an embodiment of the present technique;

FIG. 10 is a diagram for explaining the fourth aspect as an example of the method for changing a set upper limit value, which is set for a server, in the storage system as an embodiment of the present technique;

FIG. 11 is a diagram for explaining the fourth aspect as an example of the method for changing a set upper limit value, which is set for a server, in the storage system as an embodiment of the present technique; and

FIG. 12 is a diagram schematically showing a configuration example of the storage system as a variation example of an embodiment of the present technique.

### DESCRIPTION OF EMBODIMENT

With reference to drawings, embodiments of the present technique will be described below.

[1] Description on Embodiment of the Present Technique

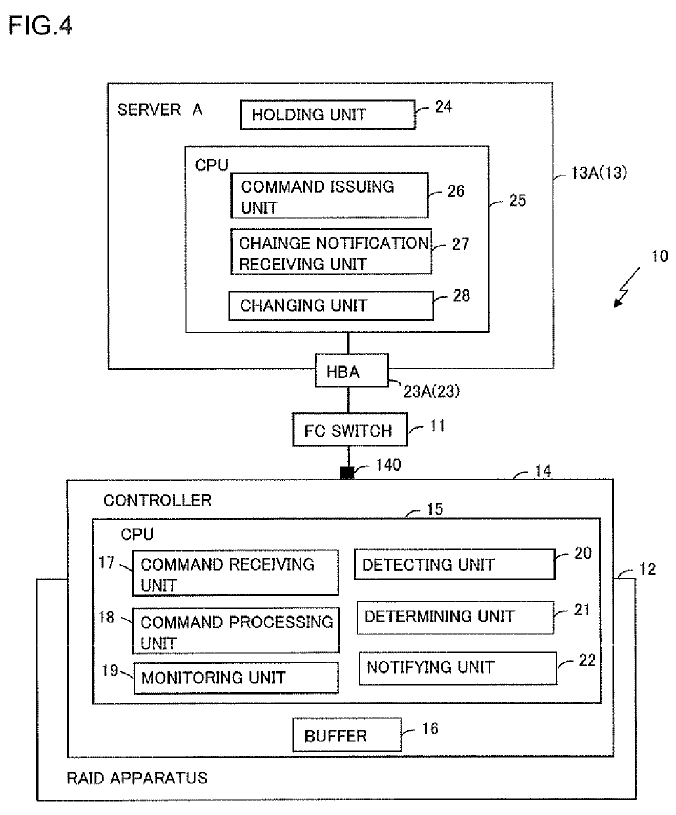

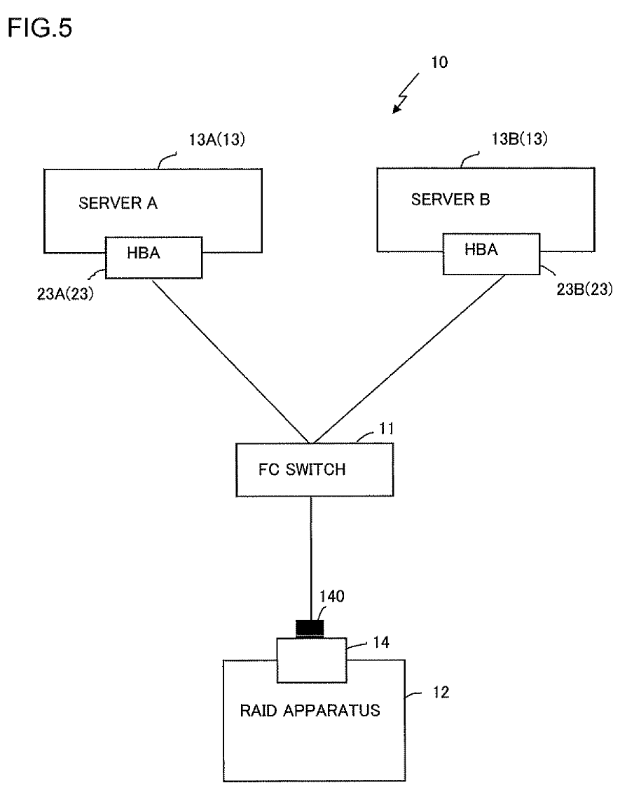

FIG. 4 is a diagram schematically showing a configuration example of a storage system as an embodiment of the present technique. FIG. 5 is a diagram schematically showing a configuration example in a case where a server is newly added to the storage system. For convenience, the detail illustrations of servers 13A and 13B, HBAs (Host Bus Adapters) 23A and 23B, a RAID apparatus 12 and a controller 14 will be omitted in FIGS. 5 to 11. Because the server 13B in FIGS. 5 to 11 has a similar functional configuration to that of the server 13A shown in FIG. 4, the detail illustration will be omitted for convenience.

As shown in FIG. 4, a storage system 10 according to an embodiment of the present technique includes an FC (Fibre Channel) switch (FC switch) 11, a RAID (Redundant Arrays of Inexpensive Disks) apparatus (or storage apparatus) 12, a server 13 (which may be a server 13A or 13B). The FC port 140 of the RAID apparatus 12 and the server 13A connect through the FC switch 11.

The FC switch 11 connects the server 13 and the RAID apparatus 12 communicably. For example, as shown in FIG. 4, in a case where one server 13A connects to the FC port 140 of the RAID apparatus 12 through the FC switch 11, the FC switch 11 connects the server 13A and the RAID apparatus 12 communicably. In a case where the server 13A and the RAID apparatus 12 connect communicably on one-to-one basis, the FC switch 11 may be provided arbitrarily. For example, one server 13A may directly connect to the FC port 140 of the RAID apparatus 12 without through the FC switch 11.

For example, as shown in FIG. 5, in a case where multiple (two in the example shown in FIG. 5) servers 13A and 13B connect to one same FC port 140 of the RAID apparatus 12 through the FC switch 11, the FC switch 11 connects the multiple servers 13A and 13B to the RAID apparatus 12 communicably.

Notably, the reference numerals 13A and 13B are used to refer to servers in a case one of multiple servers must be identified. The reference numeral 13 is used to refer to an arbitrary server.

The RAID apparatus 12 handles multiple hard disks (not shown) as one hard disk for management and performs processing according to a command issued by the server 13, which will be described later. The RAID apparatus 12 may include a controller 14, for example. The detail description on the general functions of a RAID apparatus will be omitted herein.

The controller 14 controls data communication between the RAID apparatus 12 and the server 13. The controller 14 may include a CPU (Central Processing Unit) 15 and a buffer 16, for example.

The CPU 15 may perform the calculation of numerical values, information processing and equipment control in the RAID apparatus 12. The CPU 15 may function as a command receiving unit 17, a command processing unit 18, a monitoring unit 19, a detecting unit 20, a determining unit 21 and a notifying unit 22, for example.

The command receiving unit 17 receives a command issued by a command issuing unit 26 of the server 13, which will be described later. The command receiving unit 17 may simultaneously receive multiple commands through one FC port 140, for example.

Here, the number of receivable commands is set in the RAID apparatus 12 for limiting the number of commands simultaneously receivable by one FC unit 140. The number of receivable commands may be set to an arbitrary value in accordance with the type and performance, for example, of the RAID apparatus 12 and be stored in a storage area (not shown, which may be the buffer 16, which will be described later) within the controller 14.

Then, if the commands beyond the number of receivable commands are received, the command receiving unit 17 generates a command error and notifies the server 13 connecting to the RAID apparatus 12 of Busy or Queue Full as a SCSI (Small Computer System Interface) status.

The command processing unit 18 performs command processing according to a command received by the command receiving unit 17. If the command processing completes, the command processing unit 18 may perform notification of completion of commanded processing to the server 13 having issued the command corresponding to the completed commanded processing.

The monitoring unit 19 monitors the communication state between the command receiving unit 17 and the server 13. In this embodiment, the monitoring unit 19 uses the existing functions included in the controller 14 to check the usage rate (%) of the FC port 140 as the communication state and stores the check result to a storage area within the controller 14.

As shown in FIG. 5, in a case where the multiple servers 13A and 13B connect to the one same FC port 140 of the RAID apparatus 12, the monitoring unit 19 uses the existing functions included in the controller 14 to check the usage rates of the FC port 140 by the multiple servers 13A and 13B and stores the check results in a storage area within the controller 14.

More specifically, the monitoring unit 19 checks the usage rate of the FC port 140 by the one server 13A and checks the usage rate of the FC port 140 by the other server 13B and stores the check results in a storage area within the controller 14.

The detecting unit 20 detects the number of servers connecting to the RAID apparatus 12 and may detect the number of the HBAs 23 connecting to the FC port 140.

More specifically, as shown in FIG. 4, in a case where one server 13A connects to the FC port 140 of the RAID apparatus 12, the detecting unit 20 recognizes the HBA 23A of the server 13A connecting to the FC port 140 to detect that the number of the server connecting to the RAID apparatus 12 is one. As shown in FIG. 5, in a case where the multiple servers 13A and 13B connect to the one same FC port 140 of the RAID apparatus 12, the detecting unit 20 recognizes the HBAs 23A and 23B of the servers 13A and 13B, respectively, connecting to the FC port 140 to detect that the number of servers connecting to the RAID apparatus 12 is two.

The reference numerals 23A and 23B are used to identify one of multiple HBAs. The reference numeral 23 is used to refer to an arbitrary HBA.

The determining unit 21 determines the change (increase or decrease) of the set upper limit value, which is a Max Throttle (or an upper limit value of the number of issuable commands, that is, a maximum number of issuable commands) currently set for the server 13 connecting to the FC port 140 on the basis of the communication state between the command receiving unit 17 and the server 13. In this embodiment, the determining unit 21 determines the determined upper limit value, which is a Max Throttle to be set for the server 13, on the basis of the communication state between the command receiving unit 17 and the server 13.

The determining unit 21 according to this embodiment may preset an upper limit threshold value (%) and a lower limit threshold value (%) in a storage area within the controller 14 and compares the usage rate of the FC port 140, which is monitored by the monitoring unit 19, with the preset upper limit threshold value and the lower limit threshold value to determine the value resulting from the increase or decrease of the set upper limit value, which is currently set for the server 13, as the determined upper limit value. The value resulting from the increase or decrease of the set upper limit value may be preset arbitrarily in accordance with the type and/or performance, for example, of the RAID apparatus 12 and may be set by using existing various methods.

Here, the Max Throttle refers to the maximum number of commands simultaneously issuable by one server 13. More specifically, the Max Throttle refers to the upper limit value of the total number of the unprocessed states since the command issuing unit 26 of the server 13, which will be described later, issues a command until the notification of completion of the commanded processing corresponding to the command is received from the command processing unit 18 of the RAID apparatus 12. The Max Throttle is set not to exceed the number of receivable commands of the RAID apparatus 12. As shown in FIG. 5, if the multiple servers 13A and 13B connect to one same FC port 140 of the RAID apparatus 12, the sum of the set upper limit value of the server 13A and the set upper limit value of the server 13B is set not to exceed the number of receivable commands of the RAID apparatus 12.

The determining unit 21 further determines the change of the set upper limit values, which are currently set for the servers 13A and 13B, on the basis of the number of servers 13 detected by the detecting unit 20.

In a case where the multiple servers 13A and 13B connect to one same FC port 140 of the RAID apparatus 12, the determining unit 21 further determines the change of the set upper limit values which are set for the servers 13A and 13B, on the basis of the communication states between the command receiving unit 17 and the multiple servers 13A and 13B. In this embodiment, the determining unit 21 determines the determined upper limit values for the multiple servers 13A and 13B.

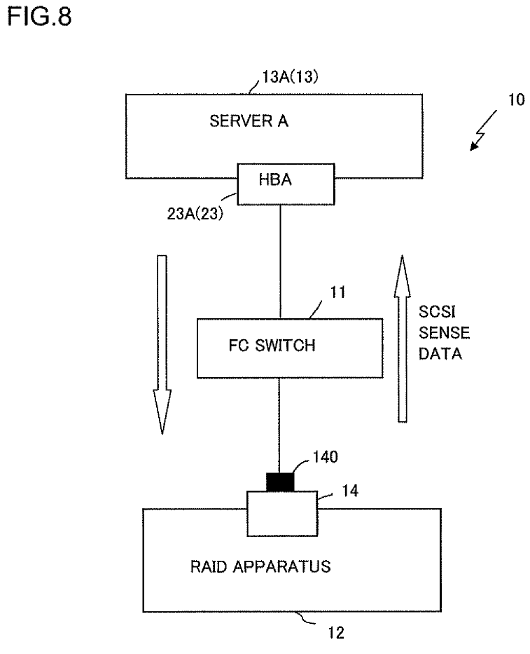

The notifying unit 22 performs change notification on the determined upper limit value, which is determined by the determining unit 21, to the server 13. Therefore, in this embodiment, the notifying unit 22 uses SCSI sense data. The notifying unit 22 transmits the SCSI sense data including the determined upper limit value to the server 13 (refer to FIG. 8). The change notification by the notifying unit 22 is performed before the notification of Busy or Queue Full as described above.

As shown in FIG. 5, in a case where the multiple servers 13A and 13B connect to one same FC port 140 of the RAID apparatus 12, the notifying unit 22 performs the change notification to at least one of the multiple servers 13A and 13B. In this embodiment, the notifying unit 22 performs the change notification to the server 13, which is determined by the determining unit 21 to change the current set upper limit value between the servers 13A and 13B.

The buffer 16 stores a command received by the command receiving unit 17 and temporarily stores subject data to be processed in accordance with a command by the command processing unit 18.

The server 13 issues a command to the RAID apparatus 12. The server 13 may be a computer including an HBA 23, a holding unit 24 and a CPU 25, for example. The CPU 25 connects to the FC port 140 of the RAID apparatus 12 through the HBA 23. The server 13 performs processing of temporarily aborting the issuance of commands if Busy or Queue Full is notified from the RAID apparatus 12, for example.

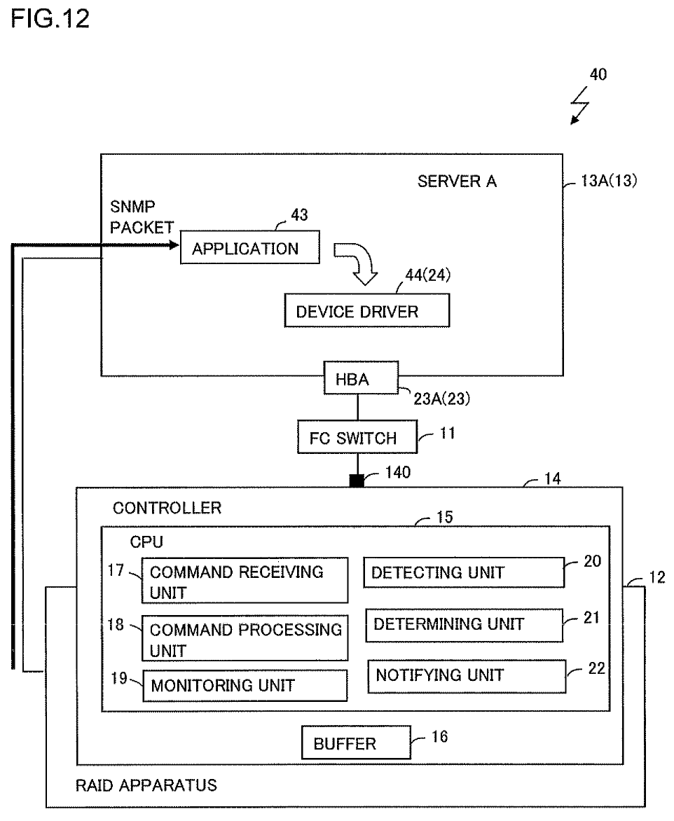

The holding unit 24 holds (stores) a device driver (not shown here, refer to the reference numeral 44 in FIG. 12, for example) and holds the set upper limit value, which is set for the device driver. The holding unit 24 sets and holds the default value compatible with the RAID apparatus 12 as the set upper limit value upon connection to the FC port 140. If the change notification is notified from the notifying unit 22 of the RAID apparatus 12 after the connection to the FC port 140, the changing unit 28, which will be described later, changes (or rewrites) the currently set upper limit value to the determined upper limit value, and the holding unit 24 holds it. Thus, the previous set upper limit value held in the holding unit 24 can be automatically set even when the server 13 is restarted.

The CPU 25 performs calculation of numerical values, information processing and equipment control in the server 13. In this embodiment, the CPU 25 implements device drivers to function as the command issuing unit 26, the change notification receiving unit 27 and changing unit 28.

The command issuing unit 26 issues a command to the RAID apparatus 12. The command issuing unit 26 sequentially issues multiple commands at predetermined time intervals not to exceed the set upper limit value held in the holding unit 24, for example.

Then, for example, if the number of commands issued (and unprocessed) simultaneously reaches the set upper limit value, the command issuing unit 26 temporarily aborts the issuance of commands. After that, if the notification of completion of command processing corresponding to one of the unprocessed commands is received, the command issuing unit 26 issues a command newly.

The change notification receiving unit 27 receives the change notification from the notifying unit 22 of the RAID apparatus 12.

The changing unit 28 changes the set upper limit value, which is currently set for the server 13, on the basis of the change notification received by the change notification receiving unit 27. The changing unit 28 rewrites the set upper limit value held in the holding unit 24 to the determined upper limit value included in the change notification received by the change notification receiving unit 27.

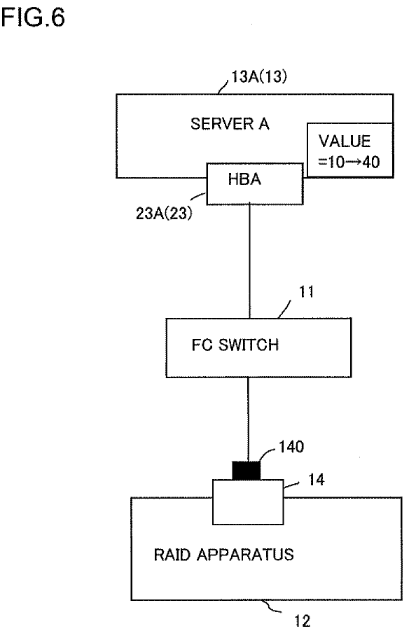

Now, examples of the method for changing the set upper limit value, which is set for the server 13 in the storage system 10 as an embodiment of the present technique, will be described in aspects [A] to [C] with reference to FIGS. 6 to 11.

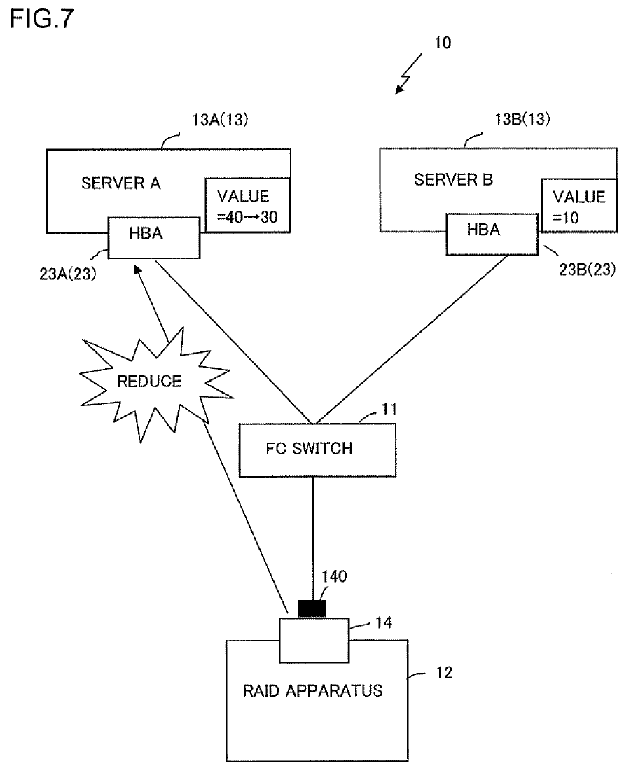

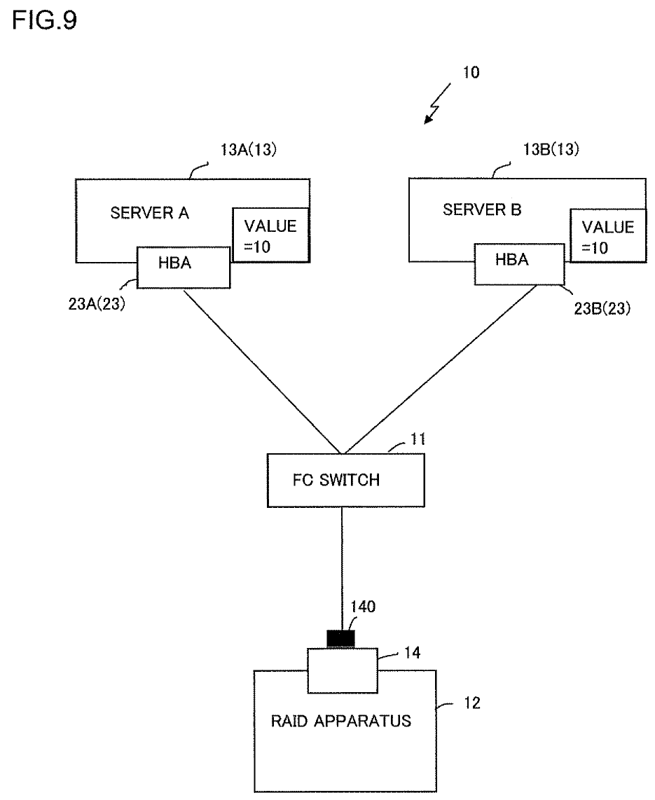

FIGS. 6 to 11 are diagrams for explaining the method for changing the set upper limit value, which is set for the server 13 in a storage system as an embodiment of the present technique. FIG. 6 is a diagram for explaining a first aspect [A], FIG. 7 is a diagram for explaining a second aspect [B], FIG. 8 is a diagram for explaining a third aspect [C-1], and FIGS. 9 to 11 are diagrams for explaining a fourth aspect [C-2].

It is assumed that an upper limit threshold value 80% and a lower limit threshold value 60% are set, and the number of receivable commands of the RAID apparatus 12 is set to 40, in the description below.

In this embodiment, if the server 13 is connected to the FC port 140, the set upper limit value of the connected server 13 is automatically set to an arbitrary value in accordance with the type of the RAID apparatus, for example. In the following description, if the server 13 is connected to the FC port 140, the set upper limit value for the connected server 13 is automatically set to 10, which is the default value compatible with the RAID apparatus 12.

[A] In Case Where One Server 13A is Connected to FC Port 140 (First Aspect):

For example, if one server 13A is connected to the FC port 140 of the RAID apparatus 12, for example, the set upper limit value for the server 13A is automatically set to 10, which is the default value.

After that, the detecting unit 20 detects that the number of the server 13 connecting to the FC port 140 is one. As shown in FIG. 6, the determining unit 21 recognizes one, which is the number of the server 13 detected by the detecting unit 20, and 10, which is the current set upper limit value for the server 13A, and determines that the determined upper limit value to be set for the server 13A as 40, which is an equal value to the number of the receivable commands of the RAID apparatus 12. The determining unit 21 recognizes the set upper limit value, which is currently set for the server 13, by receiving a vender unique command from the server 13, for example.

Then, the notifying unit 22 performs the change notification that the set upper limit value for the server 13A from 10, which is the currently set value, to 40 to the server 13A. After that, the changing unit 28 of the server 13A rewrites 10, which is the set upper limit value held in the holding unit 24 of the server 13A, to 40, which is the determined upper limit value included in the change notification received by the change notification receiving unit 27 of the server 13A.

[B] In Case Where Server 13B is Newly Added to FC Port 140 (Second Aspect)

For example, as shown in FIG. 6, in an environment where one server 13A connects to the FC port 140 of the RAID apparatus 12, as shown in FIG. 7, if the system configuration is changed to connect another server 13B to the same FC port 140 of the RAID apparatus 12, the set upper limit value of the newly added server 13B is automatically set to the default value 10.

Next, the detecting unit 20 detects that the number of servers 13 connecting to the FC port 140 is two. The determining unit 21 recognizes two, which is the number of servers 13 detected by the detecting unit 20, the set upper limit value 40, which is currently set for the server 13A, and the set upper limit value 10, which is currently set for the server 13B. After that, as shown in FIG. 7, the determining unit 21 determines the determined upper limit value of the already connected server 13A to be a value such that the sum of the set upper limit value of the server 13B and the set upper limit value of the server 13A can be under the number of receivable commands of the RAID apparatus 12. Here, the determining unit 21 determines the determined upper limit value for the server 13A to be 30, which is the value resulting from the subtraction of 10, which is the set upper limit value of the server 13B, from 40, which is the number of receivable commands of the RAID apparatus 12.

In this case, the determining unit 21 may determine arbitrary values as both of the determined upper limit value of the server 13A and the determined upper limit value of the server 13B unless the sum of the set upper limit value of the server 13B and the set upper limit value of the server 13A exceeds the number of receivable commands of the RAID apparatus 12.

Then, the notifying unit 22 performs change notification that the set upper limit value for the server 13A is reduced from the currently set value 40 to 30 to the server 13A, without performing change notification to the server 13B. After that, the changing unit 28 of the server 13A rewrites the set upper limit value 40 held in the holding unit 24 of the server 13A to the determined upper limit value 30 included in the change notification received by the change notification receiving unit 27 of the server 13A.

[C] In Case Where Communication State is Monitored by Monitoring Portion 19 (Third and Fourth Aspects)

[C-1] In Case Where One Server 13A Connects to FC Port 140 (Third Aspect)

For example, in a case where one server 13A connects to the FC port 140 of the RAID apparatus 12, as shown in FIG. 8, the determining unit 21 recognizes that the RAID apparatus 12 is greatly loaded if it keeps the state that the usage rate of the FC port 140, which is monitored by the monitoring unit 19, is higher than 80% for a predetermined period of time. After that, the determining unit 21 determines a value resulting from the reduction of the currently set upper limit value for the server 13A as the determined upper limit value in order to suppress the number of issuable commands by the server 13A so as to reduce the load on the RAID apparatus 12.

On the other hand, if the RAID apparatus 12 keeps the state that the usage rate of the FC port 140, which is monitored by the monitoring unit 19, is below a lower limit threshold value 60% continues for a predetermined period of time, the determining unit 21 determines that the load of the RAID apparatus 12 is small and the number of issuable commands by the server 13A can be increased. After that, the determining unit 21 determines a value resulting from the increase in currently set upper limit value for the server 13A as the determined upper limit value.

Then, the notifying unit 22 performs change notification that the set upper limit value for the server 13A is increased or reduced to a predetermined value to the server 13A. After that, the changing unit 28 of the server 13A rewrites the set upper limit value held in the holding unit 24 of the server 13A to the determined upper limit value included in the change notification received by the change notification receiving unit 27 of the server 13A.

[C-2] In Case Where Two Servers 13A and 13B Connect to FC Port 140 (Fourth Aspect)

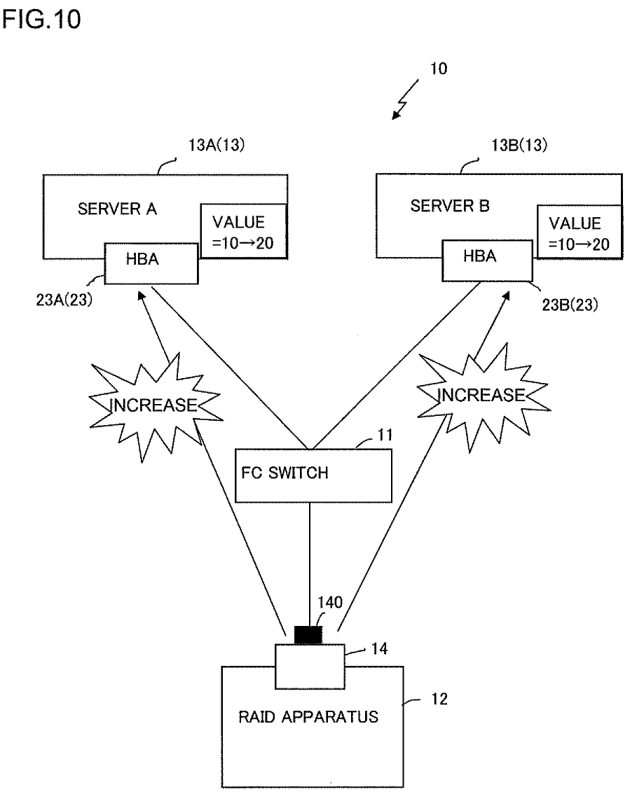

For example, in a case where two servers 13A and 13B connect to the same FC port 140 of the RAID apparatus 12 as shown in FIG. 9, the determining unit 21 determines that the load on the RAID apparatus 12 is small and the RAID apparatus 12 is not loaded even by an increase in the numbers of issuable commands by the servers 13A and 13B if it keeps the state that the usage rate of the FC port 140, which is monitored by the monitoring unit 19, is under the lower limit threshold value 60% for a predetermined period of time. Then, as shown in FIG. 10, the determining unit 21 determines a value (for example value=20) resulting from the increase in current set upper limit values (for example value=10) for the servers 13A and 13B as the determined upper limit values.

The determining unit 21 may compare the numbers of issuable commands for the servers 13A and 13B connecting to the FC port 140 in a case where the usage rate of the FC port 140 monitored by the monitoring unit 19 is lower than the lower limit threshold value 60% or higher than the upper limit threshold value 80% under the state shown in FIG. 9, excluding the case shown in FIG. 10 as described above.

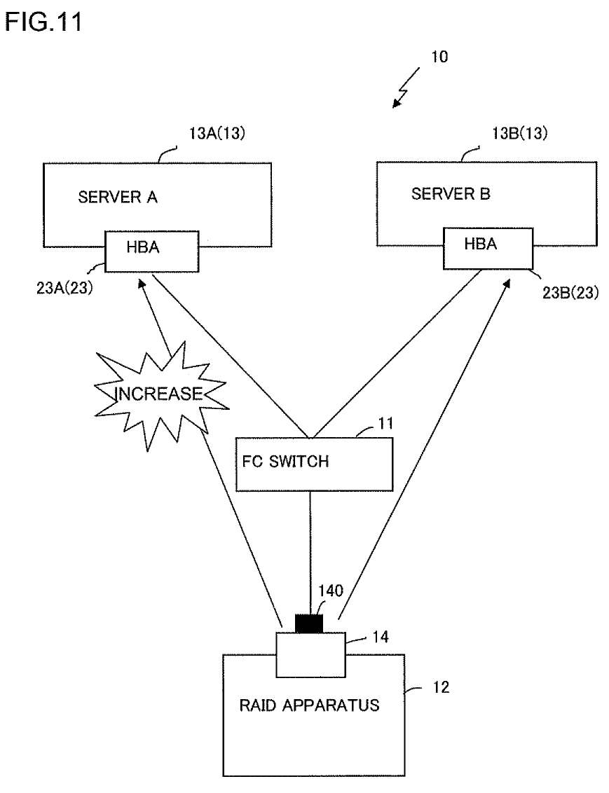

For example, if the usage rate of the FC port 140 is lower than 60% as shown in FIG. 11, the determining unit 21 compares the numbers of issuable commands for the servers 13A and 13B and thus determines the value resulting from the increase in set upper limit value currently set as the determined upper limit value for the server (which is the server 13A here) having a lower number of issuable commands, without increasing or reducing the current set upper limit value for the server (which is the server 13B here) having a higher number of issuable commands. After that, if the state that the usage rate of the FC port 140 is lower than 60% continues for a predetermined period of time, the determining unit 21 determines the value resulting from the increase in set upper limit value, which is currently set for the server 13B having a higher number of issuable commands, as the determined upper limit value. Similarly, the determining unit 21 performs the operation of alternately increasing the set upper limit value for the server 13A having a lower number of issuable commands and the set upper limit value for the server 13B having a higher number of issuable commands until the usage rate of the FC port 140 exceeds 60%.

For example, if the usage rate of the FC port 140 is higher than 80%, not shown, the determining unit 21 compares the numbers of issuable commands for the servers 13A and 13B and thus determines, as the determined upper limit value, the value resulting from the reduction in set upper limit value currently set for the server (which is the server 13B here) having a higher number of issuable commands, without increasing or reducing the current set upper limit value for the server (which is the server 13A here) having a lower number of issuable commands. After that, if the state that the usage rate of the FC port 140 is higher than 80% continues for a predetermined period of time, the determining unit 21 determines, as the determined upper limit value, the value resulting from the reduction of the set upper limit value, which is currently set for the server 13A having a lower number of issuable commands. Similarly, the determining unit 21 performs the operation of alternately reducing the set upper limit value for the server 13A having a higher number of issuable commands and the set upper limit value for the server 13B having a lower number of issuable commands until the usage rate of the FC port 140 is lower than 80%.

Also in this case, the determining unit 21 may determine arbitrary values as both of the determined upper limit value of the server 13A and the determined upper limit value of the server 13B unless the sum of the set upper limit value of the server 13B and the set upper limit value of the server 13A exceeds the number of receivable commands of the RAID apparatus 12.

Then, if the determining unit 21 determines that set upper limit values of both of the servers 13A and 13B are to be increased, the notifying unit 22 performs change notification that the set upper limit values of both of the servers 13A and 13B are to be increased to predetermined values to the servers 13A and 13B, as shown in FIG. 10. After that, the changing unit 28 of the server 13A rewrites the set upper limit value held in the holding unit 24 of the server 13A to the determined upper limit value included in the change notification received by the change notification receiving unit 27 of the server 13A. The changing unit 28 of the server 13B rewrites the set upper limit value held in the holding unit 24 of the server 13B to the determined upper limit value included in the change notification received by the change notification receiving unit 27 of the server 13B.

On the other hand, if the determining unit 21 determines to increase the set upper limit value for the server 13A only, the notification unit 22 performs change notification on the fact that the set upper limit value for the server 13A is to be increased to a predetermined value to the server 13A, as shown in FIG. 11, without performing change operation to the server 13B. After that, the changing unit 28 of the server 13A rewrites the set upper limit value held in the holding unit 24 of the server 13A to the determined upper limit value included in the change notification received by the change notification receiving unit 27 of the server 13A.

In this way, in the RAID apparatus 12 in the storage system 10 as an embodiment of the present technique, the determined upper limit value is determined on the basis of the communication state between the command receiving unit 17 and the server 13, and change notification on the determined upper limit value is performed to the server 13. In the server 13 having received the change notification, by changing the set upper limit value, which is currently set for the server 13, to the determined upper limit value on the basis of the received change notification, the set upper limit value for the server 13 can be changed automatically (and dynamically) in accordance with the communication state between the command receiving unit 17 and the server 13. Therefore, the trouble of setting the set upper limit value for the server 13 manually can be saved. As a result, even when an increased number of servers 13 connect to the RAID apparatus 12, which increases the size of the storage system 10, the time required for changing the set upper limit value for the server 13 can be reduced.

In an environment where one server 13 connects to the FC port 140 of the RAID apparatus 12, if the system configuration is changed to connect another server 13B to the same FC port 140 of the RAID apparatus 12, the determining unit 21 recognizes the number of servers 13 detected by the detecting unit 20, the set upper limit value, which is currently set for the server 13A, and the set upper limit value, which is currently set for the server 13B, and determines the determined upper limit value for the already connected server 13A to be a value such that the sum of the set upper limit value for the server 13B and the set upper limit value for the server 13A can be under the number of receivable commands of the RAID apparatus 12. Thus, the set upper limit value for the newly added server 13B and the set upper limit value for the already connected server 13A in operation can be automatically changed. Therefore, even when the server 13B is newly added, the trouble of setting the set upper limit values for the servers 13A and 13B manually can be saved, which can reduce the time required for changing the settings.

In this case, even when the set upper limit value for the newly added server 13B is set to the default value compatible with the RAID apparatus 12, the set upper limit value for the newly added server 13B and the set upper limit value for the already connected server 13A in operation can be automatically changed such that the sum of the set upper limit value, which is the default value, for the server 13B and the set upper limit value of the server 13A can be under the number of receivable commands of the RAID apparatus 12. Thus, the set upper limit value for the server 13 can be changed to a safe value, which is not a load on the RAID apparatus 12.

The detection of the number of servers 13 connecting to the RAID apparatus 12 and determination of the determined upper limit value or values on the basis of the detection result can eliminate the possibility of the incorrect counting of the number of HBAs 23 and/or the mistake of the value of the set number of receivable commands, which causes incorrect setting of the value or values of the set upper limit value or values for the server or servers 13. This can reduces the possibility of delaying processing by a command issued by the server 13 and/or causing a command error.

[2] Others

The present technique is not limited to the embodiment above and can be changed in various ways without departing from the scope and spirit of the present technique.

For example, having described that the monitoring unit 19 monitors the usage rate of the FC port 140 as the communication state between the command receiving unit 17 and the server 13 in accordance with the embodiment above, the present technique is not limited thereto. For example, as the communication state between the command receiving unit 17 and the server 13, the monitoring unit 19 may monitor the usage rate of the CPU 15 within the controller 14 or the number of commands (or the number of I/Os) received by the command receiving unit 17 within a predetermined period of time. Alternatively, as the communication state between the command receiving unit 17 and the server 13, the monitoring unit 19 may monitor the status of use of the buffer 16, which is obtained along with a command received by the command receiving unit 17 or may monitor the transfer rate of the FC port 140 or information based on the server (WWN) being accessing. Those cases can be implemented by using the existing functions included in the controller 14, and the communication states of the multiple servers 13A and 13B are monitored in a case where the multiple servers 13A and 13B connect to the one same FC port 140 of the RAID apparatus 12.

Having described that, in the embodiment, the determining unit 21 of the RAID apparatus 12 determines a determined upper limit value, which is a specific value, and the changing unit 28 of the server 13 changes a setting change value to the determined upper limit value included in the change notification, the present technique is not limited thereto. For example, by allowing the selection and setting with a high regard for QOS (bandwidth guarantee), responsiveness or throughputs, the indicator according to the setting may be used as the change notification.

For example, in the RAID apparatus 12, the determining unit 21 may determine whether the set upper limit value, which is currently set for the server 13, is to be increased or reduced, and the notifying unit 22 may perform change notification on the fact that the set upper limit value is to be increased or change notification on the fact that the set upper limit is to be reduced in accordance with the determination result by the determining unit 21. In this case, in the server 13 having received the change notification, the changing unit 28 changes the set upper limit value, which is currently set for the server 13, to a value resulting from the increase of the value by a certain ratio if the change notification that the set upper limit value is to be increased is received by the change notification receiving unit 27. The changing unit 28 changes the set upper limit value, which is currently set for the server 13, to a value resulting from the reduction of the value by a certain ratio if the change notification that the set upper limit value is to be reduced is received by the change notification receiving unit 27. Here, the certain ratio for increasing or reducing the set upper limit value is predefined in accordance with the performance and/or the type, for example, of the RAID apparatus 12.

The storage system 10 in the embodiment is applicable to an HA (High Availability) cluster, not shown. In the HA cluster, a set upper limit value of the assignment ratio 90% may be assigned to one running server 13 while a set upper limit value of the assignment ratio 10% may be assigned to the other standby server 13, and the running server and the standby server are switched alternately at a predetermined time. If the running server and standby server are switched therebetween, a switching notifying unit (not shown) of one server 13 performs switching notification on the fact that the running state is switched to the standby state to the RAID apparatus 12 while a switching notifying unit (not shown) of the other server 13 performs switching notification on the fact that the standby state is switched to the running state to the RAID apparatus 12. After that, if a switching notification receiving unit (not shown) of the RAID apparatus 12 receives the switching notifications from the servers 13, the determining unit 21 of the RAID apparatus 12 determines to assign the determined upper limit value of the assignment ratio 10% to the one server 13 switched from the running state to the standby state while the determined upper limit value of the assignment ratio 90% is assigned to the server 13 switched from the running state to the standby state, on the basis of the received switching notification.

Thus, in the HA cluster, even if the running state and the standby state are switched dynamically, the assignment ratios of the set upper limit values to the servers 13 can follow the switching. Therefore, the proper setting can be performed in consideration of the operational status of the server 13.

FIG. 12 is a diagram schematically showing a configuration example of a storage system as a variation example of one embodiment of the present technique.

Having described that the notifying unit 22 uses SCSI Sense to transmit the change notification including SCSI sense information to the server 13 in the embodiment above, the present technique is not limited thereto. For example, the change notification may be transmitted over a network.

For example, a storage system 40 shown in FIG. 12 includes a notifying unit 41 instead of the notifying unit 22 in the embodiment above, and the remaining part has the same configuration as that of the storage system 10 in the embodiment above.

Because the same reference numerals as the aforesaid reference numerals refer to the same or substantially same parts, the detail descriptions thereon will be omitted herein.

As shown in FIG. 12, the notifying unit 41 in the RAID apparatus 12 uses a method for notification over a network to transmit the determined upper limit value, which is determined by the determining unit 21, included in an SNMP (Simple Network Management Protocol) packet as a change notification to the server 13 over a LAN 42. In the server 13A having received the SNMP packet, an application 43 functioning as the changing unit 28 is executed to change the set upper limit value set for the device driver 44 stored in the holding unit 24 to the determined upper limit value included in the SNMP packet. This can provide the same operational effects as those of the aforesaid embodiment.

Then, the CPU 15 of the RAID apparatus 12, the CPU 25 of the server 13 and a management apparatus (not shown) connecting to the storage system 10 may execute a control program for the storage system to function as the command receiving unit 17, command processing unit 18, monitoring unit 19, detecting unit 20, determining unit 21 and notifying unit 22 or 41.

The program (or control program for a storage system) for implementing the functions as the command receiving unit 17, command processing unit 18, monitoring unit 19, detecting unit 20, determining unit 21 and notifying unit 22 or 41 may be provided in a form recorded in a computer readable recording medium such as a flexible disk, a CD (such as a CD-ROM, a CD-R and a CD-RW), a DVD (such as a DVD-ROM, a DVD-RAM, a DVD-R, a DVD+R, a DVD-RW and a DVD+RW), a magnetic disk, an optical disk and a magneto-optical disk. A computer reads the program from the recording medium and transfers and stores it to an internal storage device or an external storage device for use. Alternatively, the program may be recorded on a storage device (recording medium) such as a magnetic disk, an optical disk, a magneto-optical disk and a semiconductor disk including a non-volatile semiconductor memory and may be provided to a computer from the storage device through a communication path.

The functions as the command receiving unit 17, command processing unit 18, monitoring unit 19, detecting unit 20, determining unit 21 and notifying unit 22 or 41 may be implemented by executing the program stored in an internal storage device by a microprocessor of a computer. In this case, the computer may read and execute the program recorded on the recording medium.

In this embodiment, a computer is a concept including hardware and an operating system and refers to hardware that operates under the control of the operating system. In a case where the operating system is not necessary, and the application program is operated by hardware independently, the hardware itself is equivalent to the computer. The hardware may include at least a microprocessor such as a CPU and means for reading a computer program recorded on a recording medium. In this embodiment, the RAID apparatus 12 and the server 13 function as the computer.

The recording medium in this embodiment may be any of various computer readable media such as an IC card, a ROM cartridge, a magnetic tape, a punch card, an internal storage device (or a memory such as a RAM and a ROM) in a computer, an external storage device, a printed material on which a code such as a barcode is printed in addition to the flexible disk, CD, DVD, magnetic disk, optical disk, magneto-optical disk and semiconductor disk.

The disclosed technology provides at least one of following effects or advantages:

[1] Because the set upper limit value of the server can be changed automatically (or dynamically), the trouble of manual setting of the set upper limit value of the server can be saved.

[2] The time required for changing the set upper limit value of the server can be reduced even when the number of servers connecting to the storage apparatus increases and the size of the storage system increases.

[3] The trouble of manual setting of the set upper limit value of each server can be saved, which can reduce the time required for changing the setting, even when another server is newly added.

[4] The elimination of the possibility of setting an incorrect value as the set upper limit value for a server can reduce the possibility of delaying processing in response to a command issued by the server or causing a command error

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A storage system comprising:
a server for setting set upper limit value of the number of issuable commands; and
a storage apparatus for processing the commands issued by the server,
the storage apparatus including:
a detecting unit for detecting the number of the server connecting to the storage apparatus;
a determining unit for determining the change of the set upper limit value set for the server on the basis of the number of the server detected by the detecting unit; and
a notifying unit for performing change notification regarding the change of the set upper limit value determined by the determining unit to the server, and
the server including:
a change notification receiving unit for receiving the change notification from the notifying unit; and
a changing unit for changing the set upper limit value set for the server on the basis of the change notification received by the change notification receiving unit.

2. The storage system according to claim 1, wherein the storage apparatus further includes a command receiving unit that receives a command issued by the server, wherein the determining unit changes the set upper limit value on the basis of the communication state between the command receiving unit and the server.

3. The storage system according to claim 2, wherein the communication state is the number of commands received by the command receiving unit within a predetermined period of time.

4. The storage system according to claim 2, wherein the communication state is the status of use of a buffer, which is obtained along with the command received by the command receiving unit.

5. The storage system according to claim 2, further comprising a plurality of the servers, wherein the determining unit determines the change of the set upper limit value set for each of the plurality of servers on the basis of the communication states between the command receiving unit and the plurality of servers, and the notifying unit performs the change notification to at least one of the plurality of servers.

6. A storage apparatus for processing a command issued by a server for setting set upper limit value of the number of issuable commands, the apparatus comprising:
a detecting unit for detecting the number of the server connecting to the storage apparatus;
a determining unit for determining the change of the set upper limit value set for the server on the basis of the number of the server detected by the detecting unit; and
a notifying unit for performing change notification regarding the change of the set upper limit value determined by the determining unit to the server.

7. The storage apparatus according to claim 6, further comprising a command receiving unit that receives the command issued by the server, wherein:
the determining unit changes the set upper limit value on the basis of the communication state between the command receiving unit and the server.

8. The storage apparatus according to claim 7, wherein the communication state is the number of commands received by the command receiving unit within a predetermined period of time.

9. The storage apparatus according to claim 7, wherein the communication state is the status of use of a buffer, which is obtained along with the command received by the command receiving unit.

10. The storage apparatus according to claims 7, wherein the determining unit determines the change of the set upper limit value set for each of a plurality of the servers on the basis of the communication states between the command receiving unit and the plurality of servers, and the notifying unit performs the change notification to at least one of the plurality of servers.

11. A control method for a storage system, the method comprising the step of:
providing a server for setting set upper limit value of the number of issuable commands;
providing a storage apparatus for processing the commands issued by the server;
detecting the number of the server connecting to the storage apparatus;
determining step of determining the change of the set upper limit value set for the server on the basis of the number of the server detected by the detecting step; and
notifying step of performing change notification regarding the change of the set upper limit value determined by the determining step to the server.

12. The control method for the storage system according to claim 11, further comprising a command receiving step of receiving a command issued by the server, wherein the determining step changes the set upper limit value on the basis of the communication state between the command receiving unit and the server.

13. The control method for the storage system according to claim 12, wherein the communication state is the number of commands received by the command receiving step within a predetermined period of time.

14. The control method for the storage system according to claim 12, wherein the communication state is the status of use of a buffer, which is obtained along with the command received by the command receiving step.

15. The control method for the storage system according to claims 12, wherein the determining step determines the change of the set upper limit value set for each of a plurality of the servers on the basis of the communication states between the command the storage apparatus and the plurality of servers, and the notifying step performs the change notification to at least one of the plurality of servers.
